(19) United States
(12) Patent Application Publication
(10) Pub. No.: US 2026/0050804 A1
(43) Pub. Date: Feb. 19, 2026

(54) SYSTEM AND METHOD FOR ARTIFICIAL INTELLIGENCE BASED PREDICTIVE ANALYTICS OF ELECTRONIC USER DATA

(71) Applicant: BANK OF AMERICA CORPORATION, Charlotte, NC (US)

(72) Inventors: Kathlyn Meredith Rooney, Boston, MA (US); Marshall Adam Johnson, Summit, NJ (US); Jonathan Aguallo, Charlotte, NC (US)

(73) Assignee: BANK OF AMERICA CORPORATION, Charlotte, NC (US)

(21) Appl. No.: 19/301,508

(22) Filed: Aug. 15, 2025

Related U.S. Application Data
(60) Provisional application No. 63/683,926, filed on Aug. 16, 2024.

(51) Int. Cl. G06N 5/02

(52) U.S. Cl. CPC G06N 5/027

(57) ABSTRACT

A system is provided for artificial intelligence based predictive analytics of electronic user data. In particular, the system may comprise an artificial intelligence (“AI”) engine that continuously aggregates user data associated with a user and/or a group of users based on internal and external data sources across various different communication channels. The AI engine may then parse and tokenize the user data to generate a complete user snapshot associated with the user and/or the group of users. Based on analyzing the user data, the AI engine may generate a probability score associated with a predicted user action within the network environment. Based on the predicted user action and the probability score associated with the predicted user action, the system may drive decisioning processes within the network environment and/or generate one or more outputs to be presented on one or more user computing devices in and out of the network environment.

### CROSS-REFERENCE TO RELATED APPLICATION

This application is a non-provisional of and claims the benefit of priority to U.S. Provisional Ser. No. 63/683,926 , filed Aug. 16, 2024; the contents of which are also incorporated by reference herein.

### TECHNOLOGICAL FIELD

Example embodiments of the present disclosure relate to a system and method for artificial intelligence based predictive analytics of electronic user data.

### BACKGROUND

There is a need for an intelligent way to improve decisioning processes based on user interactions within a network environment.

### BRIEF SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

A system, method, and computer program product is provided for artificial intelligence based predictive analytics of electronic user data. In particular, the system may comprise an artificial intelligence (“AI”) engine that continuously aggregates user data associated with a user and/or a group of users based on internal and external data sources across various different communication channels. The AI engine may then parse and tokenize the user data to generate a complete user snapshot associated with the user and/or the group of users. Based on analyzing the user data, the AI engine may generate a probability score associated with a predicted user action within the network environment. Based on the predicted user action and the probability score associated with the predicted user action, the system may drive decisioning processes within the network environment and/or generate one or more projections, recommendations, and/or notifications to be presented on one or more user computing devices in and out of the network environment.

Accordingly, embodiments of the present disclosure provide a system, method, and computer program product for artificial intelligence based predictive analytics of electronic user data, the invention comprising: continuously monitoring and aggregating user data; determining a predicted user action based on analyzing the user data using an artificial intelligence (“AI”) engine, wherein determining the predicted user action comprises computing a probability score for occurrence of the predicted user action; generating an output using the AI engine based on determining that the probability score exceeds a predefined threshold; and transmitting the output to one or more target computing devices.

In some embodiments, continuous monitoring and aggregating user date further comprises generating a snapshot of data collection from established links, text-based transmissions, voice-based transmissions, wherein the snapshot of data comprises natural language processing for gap filling of the snapshot from the established lines, text-based transmissions, and voice-based transmissions. In some embodiments, the snapshot of data is enriched via scraping of publicly available data associated with public data feeds.

In some embodiments, transmitting the output to one or more target computing devices, further comprise transmitting a notification to an entity agent computing device within an entity network and not a user device outside the entity network.

In some embodiments, determining the predicted user action comprises computing a probability score for occurrence of the predicted user action, wherein predicted user actions include one or more recommended steps in furtherance of the predicted user action.

In some embodiments, the invention further comprises identifying one or more links between the outputs from across users associated with the user data and compare user snapshots associated with the users.

In some embodiments, the invention further comprises generating and hosting a network-accessible online portal comprising a shared user platform for graphical user interface presentation across the portal of the output.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing system for artificial intelligence based predictive analytics of electronic user data, in accordance with an embodiment of the disclosure;

FIG. 2 illustrates an exemplary machine learning subsystem architecture, in accordance with an embodiment of the invention; and

FIG. 3 illustrates a method for artificial intelligence based predictive analytics of electronic user data, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, unique characteristic information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration. ” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “resource” may refer to a tangible or intangible object that may be used, consumed, maintained, acquired, exchanged, and/or the like by a system, entity, or user to accomplish certain objectives. Accordingly, in some embodiments, the resources may include computing resources such as processing power, memory space, network bandwidth, bus speeds, storage space, electricity, and/or the like. In other embodiments, the resources may include objects such as electronic data files or values, authentication keys (e.g., cryptographic keys), document files, funds, digital currencies, and/or the like.

Embodiments of the present disclosure provide an intelligent way to generate notifications, projections, and/or recommendations based on aggregating user data from various disparate data sources and/or various communication channels. In this regard, the system may continuously aggregate user data, which may include user interactions with the system (e.g., actions taken by the user within an application or the network environment, such as interactions with certain functions or services), user-specific data (e.g., biographical information, relationships to other users, user history, and/or the like), user resource data (e.g., user resource account data, transaction history, resource acquisition and/or exchange history, and/or the like), user configuration and/or preference data (e.g., user-specific targets or milestones, user settings, and/or the like), user communications data (e.g., user e-mails or messages, voice call transcripts, web browsing history, and/or the like), and/or the like.

An artificial intelligence (“AI”) engine may determine a predicted user action based on analyzing the user data with respect to a user and/or a group of users (e.g., the target user or users), where the determining the predicted user action comprises computing a probability of the predicted user action occurring at a specified time point or time range in the future. Upon determining that said probability exceeds a predefined threshold, the system may generate an output, where the output may comprise one or more notifications, projections, and/or recommendations that may be presented on target computing devices, where the target computing devices may include the computing device of the target user and/or the computing devices of other users who are associated with the target user. The output may then be used to drive decisioning processes with respect to the target user. Various aspects and/or components of the system will now be described in turn.

### Augmentation of User Snapshot Using Ai-based Data Enrichment

As described above, the system may continuously collect data associated with the target user through various channels. In this regard the system may generate a user snapshot that may comprise all of the known information regarding the target user. The data collected on the user may include, for instance, data that has been collected based on past communications between the user and an entity with which the user has an established link or relationship. For example, the communication may include a text-based transmission (e.g., an e-mail, text message, instant message, and/or the like) transmitted from a user device of the target user to a recipient computing device within an entity's network environment (e.g., a client-facing server). In other embodiments, the past communication may be a voice based communication such as a voice message or phone conversation between the user and the entity's agent. In such a scenario, the AI engine may comprise a natural language processing (“NLP”) algorithm that the system may use to parse, analyze, and tokenize the communication to fill in the gaps in an existing user snapshot.

In an exemplary embodiment, the user may be a customer of an entity such as a financial institution that may maintain a user account for the user. During a phone conversation between the user and an agent of the entity, the user may describe a desired or fulfilled goal or milestone (e.g., purchasing a home, attending an educational institution, and/or the like). Based on the contents of the phone conversation, the AI engine may use the NLP algorithm to parse and tokenize the speech within the phone conversation to generate tokenized concepts to be appended to the user snapshot (e.g., updating the user snapshot to include the user's goals or milestones). In this way, the system may continuously enrich the user snapshot by constantly populating the gaps within the user snapshot through data obtained through the various communication channels between the user and the entity.

In some embodiments, the system may further enrich the user snapshot through various other methods. For instance, the system may scrape publicly available data associated with the user through public data feeds (e.g., public government records, social media feeds, and/or the like) to obtain additional data regarding the user. The system may further populate the user snapshot using AI-based projections using the past activity of the user. For instance, the system may analyze the transaction history of the user to determine that a user has achieved a particular milestone. In an exemplary embodiment, the system may monitor a user resource account associated with the user (e.g., a checking account) and detect that outgoing transfers to an educational institution have stopped and that incoming transfers (e.g., paychecks) have started at a certain point in time. Based on analyzing the resource account data, the system may determine that the user has achieved a milestone (e.g., entering the workforce). Subsequently, based at least partially on the user reaching the milestone, the system may generate an output with respect to the user, as described in further detail below.

### Dynamic Generation of Projections and Recommendations Based on User Data

The system may be configured to constantly monitor user actions taken within and/or outside of the entity's network environment. Based on the actions taken by the user, the system may dynamically generate one or more projections based on the past user actions of the user, where the projection may include a predicted user action that may take place in the future. The system may further compute a probability associated with the predicted user action. Upon detecting that the probability of occurrence of the predicted user action exceeds a designated threshold, the system may generate one or more notifications or recommendations regarding the predicted user action, where the notifications or recommendations may be transmitted to a computing device within the entity's network (e.g., to an agent computing device) or outside of the entity's network (e.g., to a user computing device).

In an exemplary embodiment, the system may detect a series of user actions associated with a target user, such as opening a trust account and adding one or more beneficiaries to the trust account. Based on such user actions, the system may compute a high probability of the target user preparing to execute a future resource transfer to the one or more beneficiaries to the trust account. In turn, based on computing the high probability, the system may generate and transmit one or more recommendations to one or more agent computing devices, where the one or more recommendations may comprise a recommendation to transmit a communication to the target user regarding the future resource transfer. In this regard, the communication may comprise an invitation or prompt for the target to enroll in one or more services offered by the entity.

Alternatively or in addition to the recommendations to the agent computing device, the system may transmit one or more recommendations to the user computing device of the target user, where the one or more recommendations may include prescriptive insights regarding steps that the user may take in furtherance of the goals and/or predicted user action of the target user. For instance, the steps or recommendations may include acquisition or exchange of certain resources (e.g., funds, investment vehicles, and/or the like) to optimize resource allocations for maximum projected gain. In other embodiments, the steps or recommendations may include the acquisition of certain resources in accordance with the user's preferences (e.g., sustainability).

In addition to the recommendations, the system may be configured to generate one or more resource projections associated with the target user. In this regard, the system may assess the resource status or posture of the user (e.g., the amount of resources in the user resource account, ownership of specific resources or investments, and/or the like) and predict the future status of the user. The resource projection may be presented on a graphical user interface on the user computing device of the target user, where the resource projection may further present various future metrics regarding the future status of the user (e.g., a projected resource status score, spend patterns, and/or the like).

### Generation of Recommendations Based on Tracked User Attribute Sharing

Based on the aggregated user data, the system may further identify one or more links or relationships between the target user and one or more other users tracked by the system. Upon identifying the links, the system may compare the user snapshot associated with the target user and the user snapshot associated with the one or more other users linked to the target user to determine the existence of one or more shared attributes between the user snapshots. Subsequently, the system may generate one or more recommendations based on the shared attributes, where the one or more recommendations may be transmitted to one or more user computing devices.

An exemplary embodiment is provided as follows. A target user may be a customer of an entity such as a financial institution who holds a user resource account with the entity. The system may identify one or more links between the target user and another user tracked by the system (e.g., a relative of the target user, or related user). Based on identifying the link, the system may compare the user snapshot associated with the target user with the user snapshot associated with the related user. Based on the comparison, the system may identify one or more shared attributes or characteristics (e.g., the related user may also hold a resource account with the entity, have an established relationship with the entity, and/or the like).

The system may then generate and transmit one or more recommendations and/or notifications to the target user based on detecting the shared attributes with the related user. The recommendations and/or notifications may, for instance, comprise a prompt or request for the user to enroll in one or more services provided by the entity, where the one or more services may be selected by the system based on the shared attributes. For instance, the service may be an offer to open another resource account, for increased or reduced rates, bonuses, and/or the like.

### Shared User Platform for User Group Resource Tracking

The system may provide a shared user platform that may be accessible from a number of user computing devices (e.g., computing devices of the target user and/or other users). In this regard, the system may host a network-accessible online portal comprising the shared user platform, where the user platform may be presented on a graphical user interface on each of the user computing devices that access the online portal. In some embodiments, the system may require the user and/or the user computing device to be authenticated through the online portal to access the shared user platform. Accordingly, the system may receive authentication credentials (e.g., a username and password, secure token, unique characteristic identifiers, and/or the like) from the user computing device to complete the authentication process.

The graphical user interface may be configured through one or more interface elements to present the various outputs generated by the system as described elsewhere herein. In particular, the user interface may comprise a notification and/or recommendation area for displaying the notifications and/or recommendations generated by the system. The user interface may further comprise one or more interactable elements (e.g., a clickable button, touchable region, hyperlink, and/or the like), where upon detecting that the user has interacted with the interactable element, automatically present (e.g., through a pop-up notification) an onboarding page associated with one or more services referenced within the notification and/or recommendation.

The user interface may further be configured to display the projections generated by the system. For instance, the user interface may display a visualization (e.g., bar graph, line graph, chart, table, and/or the like) of various user metrics associated with the target user. In one embodiment, the visualization may be a line graph showing the performance of one or more user resources over time. In such an embodiment, the visualization may further comprise a projection of the expected performance of the one or more user resources over time in the future. In some embodiments, a specified user (e.g., the target user) may be designated as an administrator of a group of users (e.g., the target user and related users) such that certain functionality or permissions (e.g., read and/or write) may be restricted to the administrator.

In some embodiments, the user interface may further be configured to display the resource data and/or visualizations generated from resource data of other users (e.g., users who have a link or relationship with the target user). In this regard, the resource data may include information regarding resource growth over time, resource portfolio makeup, saved resource amounts, projected resource stance or status at a future point in time, and/or the like. The user interface may further present information on shared characteristics of the related users with the target user (e.g., biographical information, milestones, life stages, and/or the like). In this way, the system may provide a consolidated view of the target user's resource status as well as the resource statuses of closely related users. In some embodiments, the graphical user interface may further comprise a file generation tool that may be used to generate data files based on the resource data of the target user and/or related users, where the data files may comprise documents, forms, communications, and/or the like. In an exemplary embodiment, the target user may use the file generation tool to generate tax forms based on the resource data collected on the target user and/or the related users.

### Resource Allocation Tracking Using Ai-powered User Agent

The system may generate an artificial intelligence-based user agent based on the user data. In this regard, the system may analyze the user activity and/or behaviors of the user to maintain an accurate user snapshot associated with the user such that the AI engine may learn the preferences and tendencies of the target user. The AI engine may then generate a user agent that may execute decisioning processes on behalf of the target user, where the decisioning processes may be based on the preferences and tendencies of the target user. In this way, the system may provide an AI-based agent that executes processes in accordance with the target user's goals.

In an exemplary embodiment, the system may generate an AI agent of a target user who has created a trust account including a plurality of beneficiaries, where one of the beneficiaries may be the AI agent that has been created based on the target user's behaviors, preferences, and/or activities. The AI agent may then generate recommendations and/or projections that may be transmitted to other users (e.g., beneficiaries of the trust), where the recommendations may include information regarding how the target user would prefer the resources within the trust are allocated. In this way, the AI agent may continue to act on behalf of the target user even in the event that the target user is unavailable.

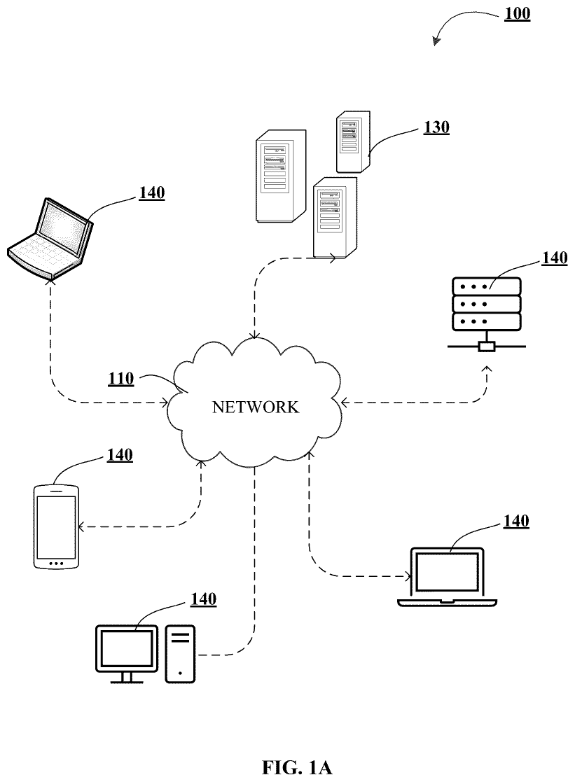

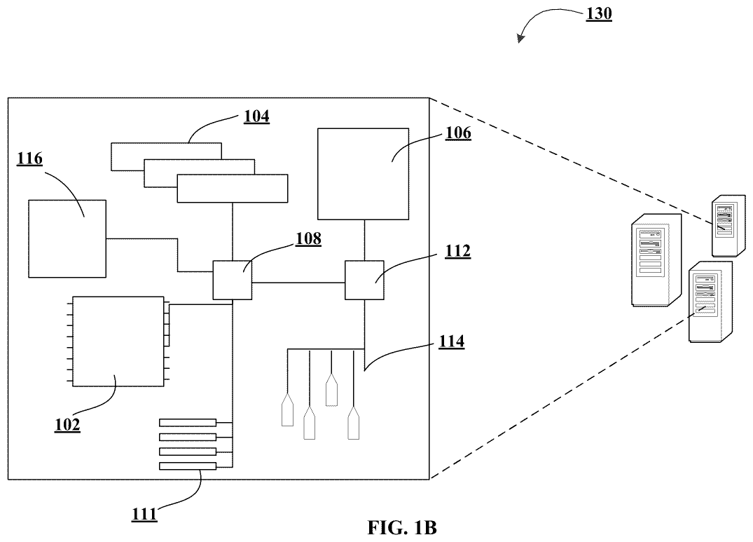

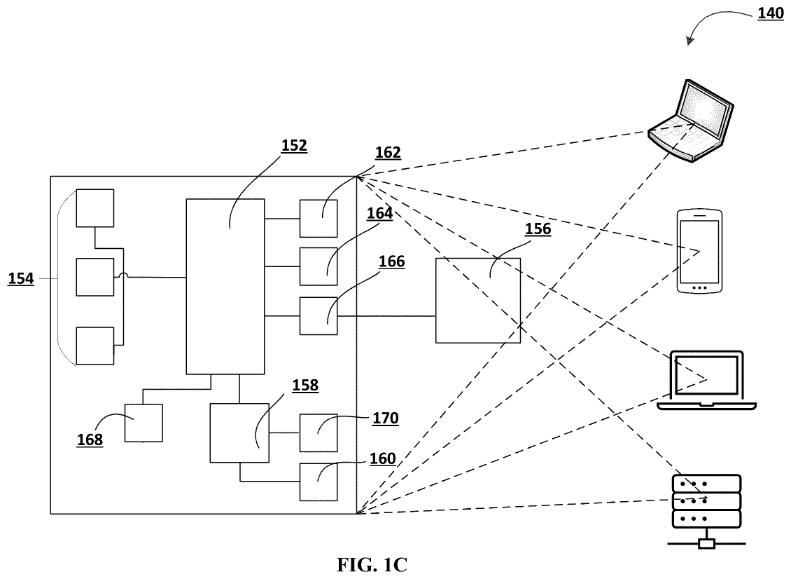

Turning now to the figures, FIGS. 1A-1C illustrate technical components of an exemplary distributed computing environment 100 for the system for artificial intelligence based predictive analytics of electronic user data. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. For instance, the functions of the system 130 and the endpoint devices 140 may be performed on the same device (e.g., the endpoint device 140). Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it. In some embodiments, the system 130 may provide an application programming interface (“API”) layer for communicating with the end-point device(s) 140.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as servers, networked storage drives, personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102 (which may also be referred to herein as a “processing device”), memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

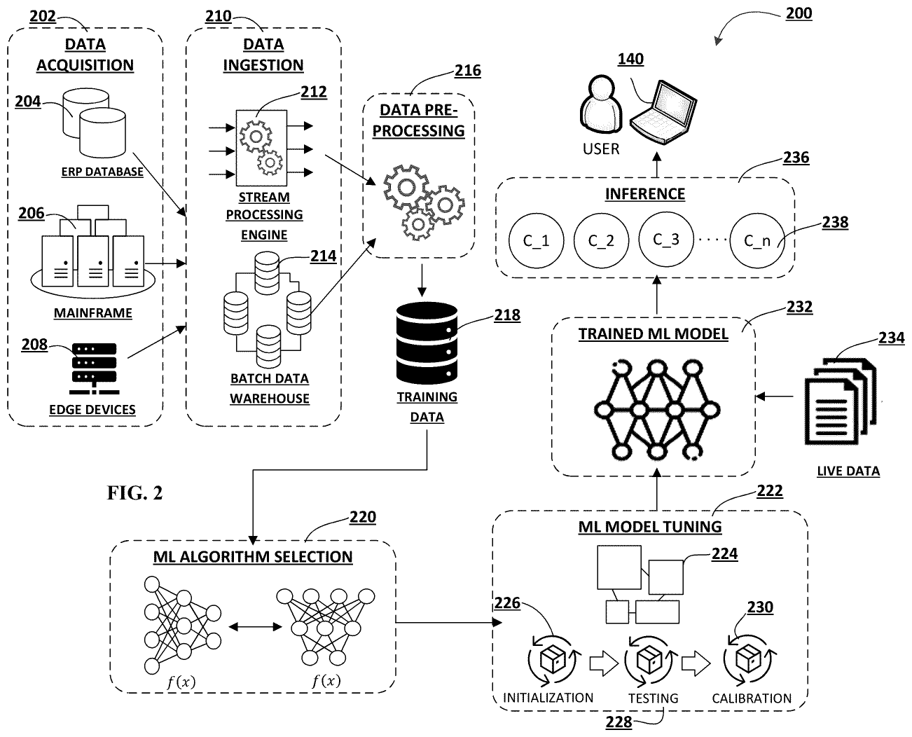

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

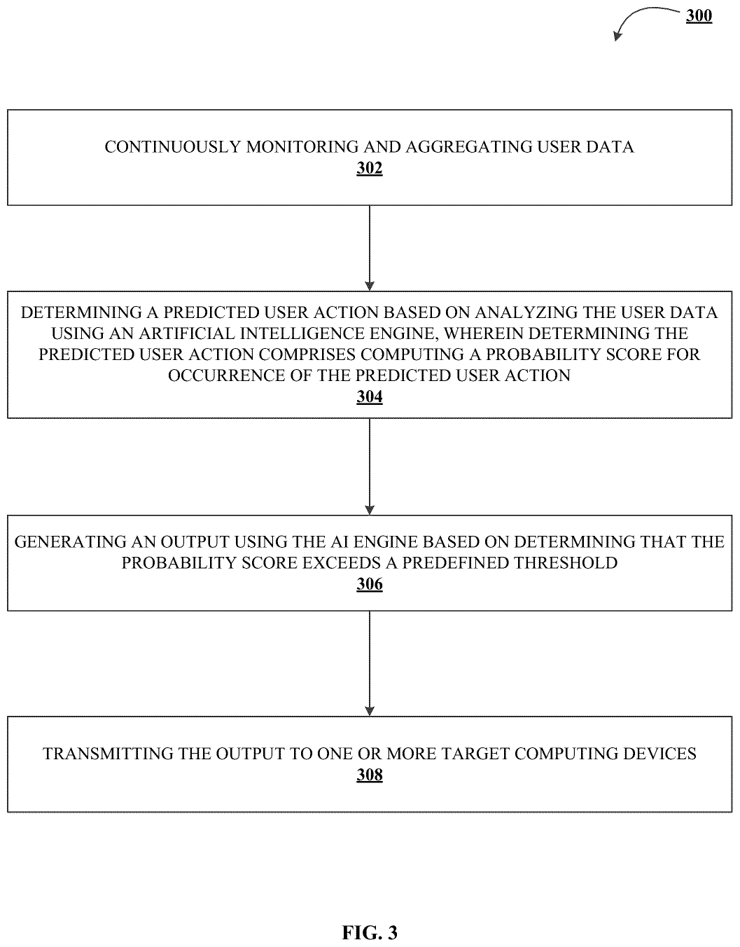

FIG. 3 illustrates a method 300 for artificial intelligence based predictive analytics of electronic user data. As shown in block 302, the method includes continuously monitoring and aggregating user data. The user data may include information such as user interactions with the system, user-specific data, user resource data, user configuration and/or preference data, user communications data, and/or the like. The user data may be aggregated through multiple different data sources that are both internal and external to an entity's network environment. Accordingly, the data sources may include, for instance, communications from the user to the entity, publicly available databases or sites, projections generated by the system, and/or the like.

Next, as shown in block 304, the method includes determining a predicted user action based on analyzing the user data using an artificial intelligence engine, wherein determining the predicted user action comprises computing a probability score for occurrence of the predicted user action. The probability score may be adjusted (e.g., increased or decreased) by the system as the system continuously collects user data associated with a target user. In this regard, the system may detect a pattern of user activity that comprises a series of steps toward an objective of the user related to the predicted user action (e.g., purchase of a home). Each step within the series of steps may increment the probability score associated with the predicted user action such that the probability score represents the degree of confidence by the system that the user will take the predicted user action.

Next, as shown in block 306, the method includes generating an output using the AI engine based on determining that the probability score exceeds a predefined threshold. The output may be, for instance, a notification or recommendation to be taken by the target user in response to the predicted user action. For example, if the target user is an agent of the entity, the system may transmit a notification or alert to the agent containing a recommendation to engage in communication with the user associated with the predicted user action. In another embodiment, if the target user is the user associated with the predicted user action, the notification may contain a recommendation to engage in one or more services provided by the entity related to the predicted user action (e.g., enrollment in a savings account for purchase of the home). In other embodiments, the output may be a projection (e.g., growth of resources in a user resource account over time) that may take the form of a visualization (e.g., a line graph, bar graph, chart, and/or the like).

Next, as shown in block 308, the method includes transmitting the output to one or more target computing devices. The output may be presented on a graphical user interface on a user computing device associated with the target user. Accordingly, the graphical user interface may comprise an interface element (e.g., window, region, area, and/or the like) that may be configured to present the output to the user. The interface may further comprise one or more interactable regions within the interface element such that when the system detects that the user has interacted with the interface element, the system may populate another area within the graphical interface with an onboarding page configured to enroll the user in a service provided by the entity. In this way, the system provides an intelligent and efficient way to drive decisioning processes based on AI-powered analysis of aggregated user data.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for artificial intelligence based predictive analytics of electronic user data, the system comprising:
a processing device;
a non-transitory storage device containing instructions when executed by the processing device, causes the processing device to perform the steps of:
continuously monitoring and aggregating user data;
determining a predicted user action based on analyzing the user data using an artificial intelligence (“AI”) engine, wherein determining the predicted user action comprises computing a probability score for occurrence of the predicted user action;
generating an output using the AI engine based on determining that the probability score exceeds a predefined threshold; and
transmitting the output to one or more target computing devices.

2. The system of claim 1, wherein continuous monitoring and aggregating user date further comprises generating a snapshot of data collection from established links, text-based transmissions, voice-based transmissions, wherein the snapshot of data comprises natural language processing for gap filling of the snapshot from the established lines, text-based transmissions, and voice-based transmissions.

3. The system of claim 2, wherein the snapshot of data is enriched via scraping of publicly available data associated with public data feeds.

4. The system of claim 1, wherein transmitting the output to one or more target computing devices, further comprise transmitting a notification to an entity agent computing device within an entity network and not a user device outside the entity network.

5. The system of claim 1, wherein determining the predicted user action comprises computing a probability score for occurrence of the predicted user action, wherein predicted user actions include one or more recommended steps in furtherance of the predicted user action.

6. The system of claim 1, further comprising identifying one or more links between the outputs from across users associated with the user data and compare user snapshots associated with the users.

7. The system of claim 1, further comprising generating and hosting a network-accessible online portal comprising a shared user platform for graphical user interface presentation across the portal of the output.

8. A computer program product for artificial intelligence based predictive analytics of electronic user data, the computer program product comprising a non-transitory computer-readable medium comprising code causing an apparatus to perform the steps of:
continuously monitoring and aggregating user data;
determining a predicted user action based on analyzing the user data using an artificial intelligence (“AI”) engine, wherein determining the predicted user action comprises computing a probability score for occurrence of the predicted user action;
generating an output using the AI engine based on determining that the probability score exceeds a predefined threshold; and
transmitting the output to one or more target computing devices.

9. The computer program product of claim 8, wherein continuous monitoring and aggregating user date further comprises generating a snapshot of data collection from established links, text-based transmissions, voice-based transmissions, wherein the snapshot of data comprises natural language processing for gap filling of the snapshot from the established lines, text-based transmissions, and voice-based transmissions.

10. The computer program product of claim 9, wherein the snapshot of data is enriched via scraping of publicly available data associated with public data feeds.

11. The computer program product of claim 8, wherein transmitting the output to one or more target computing devices, further comprise transmitting a notification to an entity agent computing device within an entity network and not a user device outside the entity network.

12. The computer program product of claim 8, wherein determining the predicted user action comprises computing a probability score for occurrence of the predicted user action, wherein predicted user actions include one or more recommended steps in furtherance of the predicted user action.

13. The computer program product of claim 8, further comprising identifying one or more links between the outputs from across users associated with the user data and compare user snapshots associated with the users.

14. The computer program product of claim 8, further comprising generating and hosting a network-accessible online portal comprising a shared user platform for graphical user interface presentation across the portal of the output.

15. A computer-implemented method for artificial intelligence based predictive analytics of electronic user data, the computer-implemented method comprising:
continuously monitoring and aggregating user data;
determining a predicted user action based on analyzing the user data using an artificial intelligence (“AI”) engine, wherein determining the predicted user action comprises computing a probability score for occurrence of the predicted user action;
generating an output using the AI engine based on determining that the probability score exceeds a predefined threshold; and
transmitting the output to one or more target computing devices.

16. The computer-implemented method of claim 15, wherein continuous monitoring and aggregating user date further comprises generating a snapshot of data collection from established links, text-based transmissions, voice-based transmissions, wherein the snapshot of data comprises natural language processing for gap filling of the snapshot from the established lines, text-based transmissions, and voice-based transmissions.

17. The computer-implemented method of claim 15, wherein transmitting the output to one or more target computing devices, further comprise transmitting a notification to an entity agent computing device within an entity network and not a user device outside the entity network.

18. The computer-implemented method of claim 15, wherein determining the predicted user action comprises computing a probability score for occurrence of the predicted user action, wherein predicted user actions include one or more recommended steps in furtherance of the predicted user action.

19. The computer-implemented method of claim 15, further comprising identifying one or more links between the outputs from across users associated with the user data and compare user snapshots associated with the users.

20. The computer-implemented method of claim 15, further comprising generating and hosting a network-accessible online portal comprising a shared user platform for graphical user interface presentation across the portal of the output.
